(19) United States
(12) Patent Application Publication
(10) Pub. No.: US 2024/0272659 A1
(43) Pub. Date: Aug. 15, 2024

(54) SYSTEMS AND METHODS FOR CONTROLLING THERMAL ELEMENTS

(71) Applicant: Rheem Manufacturing Company, Atlanta, GA (US)

(72) Inventors: Satya Kiran Gullapalli, Ventura, CA (US); Juan Carlos Montanez, Oxnard, CA (US); Sergio F. Montalgo Salazar, Oxnard, CA (US)

(21) Appl. No.: 18/420,352

(22) Filed: Jan. 23, 2024

Related U.S. Application Data
(60) Provisional application No. 63/444,794, filed on Feb. 10, 2023.

(51) Int. Cl. G05D 23/19; H05B 1/02

(52) U.S. Cl. CPC G05D 23/1951; H05B 1/0297

(57) ABSTRACT

A system for maintaining a volume of fluid in a predetermined temperature range includes a thermal element configured to one or both of heat or cool the volume of fluid. A sensor may be configured to detect a temperature of the volume of fluid. A controller may be configured to compare the temperature with a tolerance range including a set point between a lower limit and an upper limit. The controller may switch the thermal element on or off in response to the comparison as a switching event. The controller may further adjust the tolerance range in response to a rate of switching events.

### CROSS-REFERENCE TO RELATED APPLICATION

This application claims the benefit of U.S. Application No. 63/444,794, filed Feb. 10, 2023, the entirety of which is hereby incorporated by reference.

### TECHNICAL FIELD

The present disclosure is generally in the field of temperature control, and more particularly related to systems and methods for controlling a thermal element based on a set point.

### BACKGROUND

Various appliances operate within a set temperature range. For example, water heaters or pool heaters may maintain a volume of water in a predetermined temperature range. Heating, ventilation, and air conditioning (HVAC) systems may also maintain an environment in a predetermined temperature range. A set point may be used to determine when a heating element or a cooling element of an appliance is turned on or switched off. For example, in an appliance that operates in a heating mode, a heating element may be turned on when a detected temperature is less than a set point, and switched off when the detected temperature is equal to or greater than the set point. In an appliance that operates in a cooling mode, a cooling element may be turned on when the detected temperature is greater than a set point, and switched off when the detected temperature is equal to or less than the set point.

The ambient environment or conditions of use affect the temperature of a volume of fluid (for example, air or water). For example, relatively large swings or cycles in ambient temperatures may cause the temperature of the volume of fluid to change or cycle. Such changes may in turn result in cycling of an appliance tasked with maintaining the volume of fluid within a particular range, by heating and/or cooling.

### SUMMARY

The present disclosure describes systems and methods for a volume of fluid in a predetermined temperature range by controlling a thermal element based on a set point.

In embodiments, the present disclosure describes a system for maintaining a volume of fluid in a predetermined temperature range. The system includes a thermal element configured to one or both of heat or cool the volume of fluid. The system further includes a sensor configured to detect a temperature of the volume of fluid. The system further includes a controller. The controller is configured to receive a signal from the sensor indicative of the temperature of the volume of fluid. The controller is further configured to compare the temperature of the volume of fluid with a tolerance range including a set point between a lower limit and an upper limit. The controller is further configured to switch the thermal element on or off in response to the comparison as a switching event. The controller is further configured to determine a rate of switching events. The controller is further configured to adjust the tolerance range in response to the rate of switching events.

In embodiments, the present disclosure describes a method for maintaining a volume of fluid in a predetermined temperature range. The method includes receiving, by a controller, a signal from a sensor indicative of a temperature of the volume of fluid. The method further includes comparing, by the controller, the temperature of the volume of fluid with a tolerance range comprising a set point between a lower limit and an upper limit. The method further includes switching, by the controller, a thermal element on or off in response to the comparison as a switching event. The method further includes determining, by the controller, a rate of switching events. The method further includes adjusting, by the controller, the tolerance range in response to the rate of switching events.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a diagram showing a system for maintaining a volume of fluid in a predetermined temperature range.

FIG. 2 is a block diagram showing the system of FIG. 1.

FIG. 3 is an example method block diagram.

The present disclosure provides a more detailed and specific description with reference to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

A thermostat or other controller may cycle a thermal element in response to a sensed temperature of a target fluid, for example, to maintain the target fluid at or close to a set point or within a predetermined temperature range. Extended or frequent cycling or switching may impact the life of a product including a thermal element, for example, leading to premature failures due to increased thermal cycling on the components. Systems according to the present disclosure may adjust cycling in response to a count or frequency of switching events, such that cycling of a thermal element may be reduced. For example, in swimming pool heaters, such reduction in cycling may help in preventing a heating unit from turning on and off a significant amount of times. Cycling may result from increased heating or cooling requirements, for example, in a hot tub heater, spa, or sauna, or where a heating or cooling system or appliance may be oversized for a particular application or volume of fluid being heated or cooled. Reducing cycling may also extend the life of auxiliary components, such as ignitors or pilots used to facilitate turning a thermal element on and off for every heat cycle.

Similarly, compressor cycling may be reduced in systems such as heat pumps and air conditioners. In electrical heaters, cycling of certain electrical components such as thyristors may be mitigated.

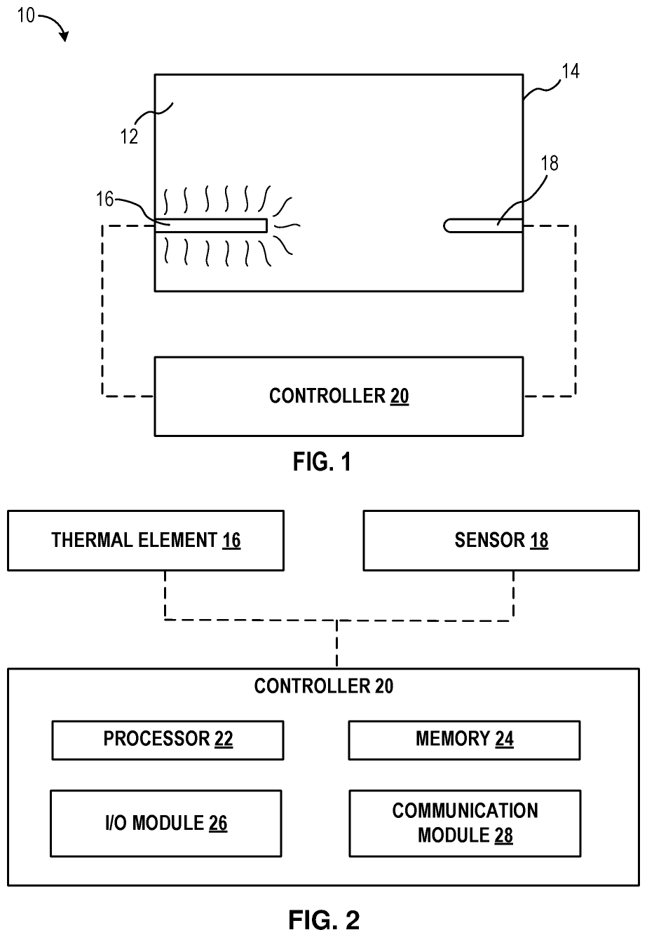

FIG. 1 is a diagram showing a system 10 for maintaining a volume of fluid 12 in a predetermined temperature range. The volume of fluid may be liquid or gaseous. For example, the volume of fluid may include water, air, nitrogen, carbon dioxide, or a refrigerant.

For example, the volume of fluid may include water in a swimming pool, hot tub, spa, or water heater, and the temperature range may be ranges suitable for recreational activities, exercise, or competitive activities. The ranges may differ based on environmental conditions, energy costs, and application of use. For example, a water temperature suitable for recreational or leisure activities may be relatively higher than that used for exercise or for a sports event. Alternatively, the volume of fluid may be air in an interior environment, such as a residential or commercial space, or an interior of a vehicle, an aircraft, or any transportation vessel. In embodiments, the volume of fluid may be air or gas in a controlled environment or chamber, for example, an interior of a refrigerator or a freezer, or an oven. Thus, different applications may be associated with different predetermined temperature ranges.

The system may include a housing 14 for holding the volume of fluid 12. The housing 14 may include a swimming pool, a water heater, a hot tub, a sauna, a room, a building, heating or cooling equipment, industrial equipment, transportation vessel, or any housing within which a temperature is to be maintained within the predetermined temperature range. The predetermined temperature range may be defined in terms of lower and upper bounds of the temperature range, or a tolerance range about a set point.

The system 10 further includes a thermal element 16 configured to one or both of heat or cool the fluid 12. For example, the thermal element 16 may function solely as a heating element, solely as a cooling element, or as both a heating and cooling element. Thus, the thermal element 16 may be operable in solely a heating mode, solely a cooling mode, or a combination of heating and cooling modes. In embodiments, the thermal element 16 may include one or more sub-elements, and any number of the sub-elements may include heating or cooling elements. Further, the system 10 may include a single thermal element 16, or a plurality of thermal elements. Each thermal element of the plurality of thermal elements may be identical or differ in structure, size, or function. For example, one or more thermal elements of the plurality of thermal elements may be heating elements, while one or more of other elements may be cooling elements, while one or more still further elements may be heating or cooling elements.

The thermal element 16 may include a water heater, for example, a pool heater. The water heater may heat separate volumes of water in batches, or a continuous stream of flowing fluid. The thermal element 16 may include a gas furnace or electric air heater. For example, the thermal element 16 or a heating element of the thermal element 16 may include a furnace including an igniter. The heating element, whether for liquid or air, may include a resistive heating element.

In embodiments, the thermal element 16 includes a heating, ventilation, and air conditioning (HVAC) component, and the volume of fluid 12 is a volume of air. The HVAC component may be an air conditioner component, a heat pump component, or a furnace component.

The system 10 further includes a sensor 18 configured to detect a temperature of the volume of fluid 12. The sensor 18 may include a thermocouple, a bimetallic thermostat, a semiconductor sensor, a thermistor, such as a negative temperature coefficient thermistor, an infrared sensor, a resistance temperature detector, or any other suitable sensor. The sensor 18 may be used to detect the temperature of the volume of fluid 12, and turn the thermal element on or off in response to the temperature.

While sensor 18 may be spaced from the thermal element 16 as shown in FIG. 1, in other embodiments, the sensor 18 may be adjacent the thermal element 16, or be provided in an enclosure or housing together with the thermal element 16. In such embodiments, the sensor 18 may be oriented away from the thermal element 16, such that the sensor 18 senses the temperature of a portion of fluid 12 not directly heated or cooled by thermal element 16.

The system 10 may include additional sensors to detect temperature at different distances relative to the thermal element 16, for example, to obtain a temperature map at different locations through the fluid 12.

The system further includes a controller 20. The controller 20 is configured to receive a signal from the sensor 18 indicative of the temperature of the volume of fluid 12. The controller 20 is further configured to compare the temperature of the volume of fluid 12 with a tolerance range including a set point between a lower limit and an upper limit.

The set point may be an average of the lower limit and the upper limit, so that the lower limit and the upper limit are symmetric about the set point. Alternatively, the set point may be relatively closer to the lower limit or the upper limit. For example, the set point may be greater than the average of the lower limit and the upper limit, or be less than the average of the lower limit and the upper limit. Such asymmetric tolerance ranges may be used if it is of greater importance to avoid exceeding one of the upper or lower limits than another of the upper or lower limits. Thus, there may be greater tolerance to one of the upper limit or lower limit, or equal tolerance relative to both the upper and lower limits.

The controller is further configured to switch the thermal element 16 on or off in response to the comparison as a switching event. For example, the controller 20 is configured to, in a heating mode, switch the thermal element 16 on in response to determining that the temperature is less than the lower limit, and switch the thermal element 16 off in response to determining that the temperature is equal to or greater than the set point. The controller 20 may be further configured to, in the heating mode, switch the thermal element 16 off in response to determining that the temperature is equal to or greater than the upper limit.

The controller 20 may similarly operate the thermal element 16 to cool the fluid 12.

For example, the controller 20 may be configured to, in a cooling mode, switch the thermal element 16 on in response to determining that the temperature is greater than the upper limit, and switch the thermal element 16 off in response to determining that the temperature is equal to or less than the set point. The controller 20 may be further configured to, in the cooling mode, switch the thermal element 16 off in response to determining that the temperature is equal to or less than the lower limit.

In this way, regardless of whether the thermal element 16 is used for heating or cooling the fluid 12, the controller 20 may control switching of the thermal element 16 to maintain the temperature of the fluid 12 at or relatively close to the set point, or generally within the tolerance range.

Toggling of the thermal element 16 may result in fatigue or aging, or increase transient phenomena associated with switching the state of the thermal element. Such cycling may impact the useful life of the system, for example, leading to premature failures due to thermal cycling of various components.

The controller 20 may modify the tolerance range in response to switching or cycling. For example, the controller 20 may be further configured to determine a rate of switching events. The controller 20 may be further configured to adjust the tolerance range in response to the rate of switching events. For example, the controller 20 may be configured to adjust the tolerance range to reduce the rate of switching events. The adjusted tolerance range may continue to include the set point, or some acceptable temperature between the lower limit and the upper limit, so that the controller 20 ultimately continues controlling the temperature of the fluid 12 relatively close to the set point.

The adjustment to the tolerance range may include modifying one or both of the lower limit or the upper limit. For example, the controller 20 may be configured to broaden the tolerance range by one or both of increasing the upper limit and reducing the lower limit. The controller 20 may further be configured to broaden the tolerance range no more than a predetermined maximum upper limit and no less than a predetermined minimum lower limit. For example, the predetermined maximum upper limit and minimum lower limit may be “hard” or “stop” limits, while the operational upper limit and lower limit may be “soft” limits.

The controller 20 may further be configured to narrow the tolerance range by one or both of reducing the upper limit and increasing the lower limit. For example, in a first stage of operation, the controller 20 may have broadened the tolerance range. In a subsequent second stage of operation, the controller 20 may determine that switching events have reduced in count or frequency, such that the tolerance range may be suitably narrowed again. The narrowing of the tolerance may promote increasing toggling of the thermal element 16 back to an initial or otherwise acceptable extent. Thus, the controller 20 may adjust the effective width of the tolerance range, in response to a frequency or count of cycling or switching events.

FIG. 2 is a block diagram showing the system 10 of FIG. 1. The controller 20 may include a processor 22, a memory 24, an input/output (I/O) module 26, and a communication module 28.

The controller 20 may be housed in a housing. The controller 20 may be a static device fixedly or removably mounted to a surface, for example, a wall or another surface of the housing 14, or placed in an interior of or exterior to the housing 14. The controller 20 may be a computing device, for example, a personal computer, a desktop, a tablet, a laptop, a cellphone, a cloud-connected device, a handheld device, or some other computing device. In some embodiments, the controller 20 may be a dedicated device. In some embodiments, the controller 20 may be implemented in a thermostat unit.

As seen in FIG. 2, the controller 20 may include the processor 22 and the memory 24. The processor 22 may be configured to execute instructions stored on the memory 24, for example, to implement a method or a process. The memory may include a non-transitory storage medium.

The controller 20 may further include the I/O module 26. The I/O module 26 may include circuitry for receiving and sending signals indicative of data or instructions. The I/O module 26 may include a transceiver for wireless communications and a bus for wired communications.

The controller 20 may further include a communication module 28. The communication module 28 may interface with components within the controller 20, or components external to the controller 20. For example, the controller 20 may send control signals or receive signals to or from an internal or external component via the communication module 28. The communication module 28 may be configured to provide wireless or wired communication. The communication module 28 may include hardware, firmware, or software for providing communication via Ethernet, Bluetooth, Wi-Fi, cellular networks, or any other communication protocol. In embodiments, the controller 20 may not include a separate communication module 28, and the I/O module 26 or another module may perform functions described with reference to the communication module 28.

The controller 20 may send control signals to one or more components, such as to the thermal element 16 or the sensor 18, or may receive feedback signals from these or other components or devices, for example, feedback indicating the status of the respective components or devices, such as operational status, maintenance alerts, failure warnings, or other operational parameters.

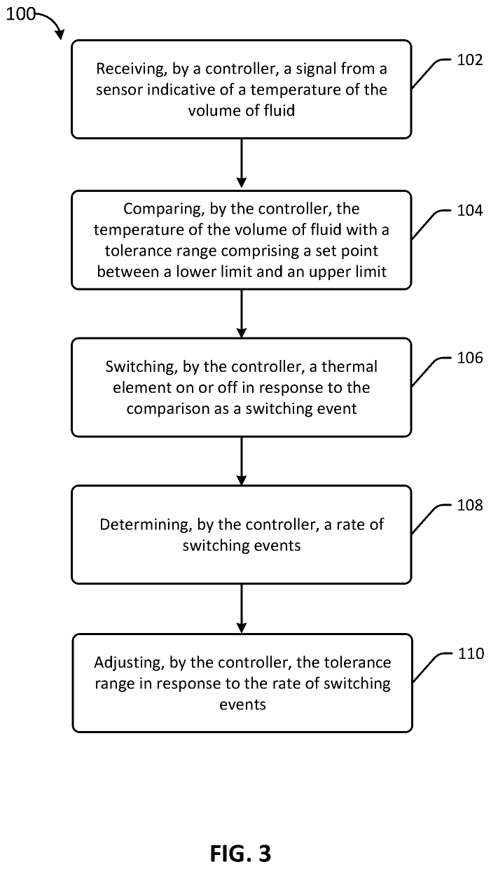

In FIG. 3, an example method block diagram is depicted. In embodiments, the present disclosure describes a method for maintaining a volume of fluid in a predetermined temperature range 100. At block 102, the method includes receiving, by a controller, a signal from a sensor indicative of a temperature of the volume of fluid. At block 104, the method further includes comparing, by the controller, the temperature of the volume of fluid with a tolerance range comprising a set point between a lower limit and an upper limit. The set point may be an average of the lower limit and the upper limit.

At block 106, the method further includes switching, by the controller, a thermal element on or off in response to the comparison as a switching event. At block 108, the method further includes determining, by the controller, a rate of switching events. At block 110, the method further includes adjusting, by the controller, the tolerance range in response to the rate of switching events.

The adjusting may be configured to reduce the rate of switching events. The adjusting may include, by the controller, broadening the tolerance range by one or both of increasing the upper limit and reducing the lower limit. In embodiments, the adjusting includes, by the controller, broadening the tolerance range no more than a predetermined maximum upper limit and no less than a predetermined minimum lower limit.

The method may further include, by the controller, in a heating mode, switching the thermal element on in response to determining that the temperature is less than the lower limit. The method may further include, by the controller, in the heating mode, switching the thermal element off in response to determining that the temperature is equal to or greater than the set point.

The method may further include, by the controller, in a cooling mode, switching the thermal element on in response to determining that the temperature is greater than the upper limit. The method may further include, by the controller, in the cooling mode, switching the thermal element off in response to determining that the temperature is equal to or less than the set point.

The thermal element controlled by the controller in the method may include one or both of a heating element or a cooling element. For example, the thermal element may include a water heater, and the volume of fluid may be a volume of water.

The thermal element controlled by the controller in the method may include a heating, ventilation, and air conditioning (HVAC) component, and the volume of fluid may be a volume of air.

Modifications and variations of the assemblies, devices, and methods described herein will be obvious to those skilled in the art from the foregoing detailed description. Such modifications and variations are intended to come within the scope of the appended claims.

It should be appreciated that the program module(s), applications, computer-executable instructions, code, or the like depicted in FIG. 2 are merely illustrative and not exhaustive and that processing described as being supported by any particular module may alternatively be distributed across multiple module(s) or performed by a different module. In addition, various program module(s), script(s), plug-in(s), application programming interface(s) (API(s)), or any other suitable computer-executable code hosted locally on the controller, and/or hosted on other computing device(s) accessible via one or more networks, may be provided to support functionality provided by the program module(s), applications, or computer-executable code and/or additional or alternate functionality. Further, functionality may be modularized differently such that processing described as being supported collectively by the collection of program module(s) may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) may be implemented, at least partially, in hardware and/or firmware across any number of devices.

It should further be appreciated that the controller may include alternate and/or additional hardware, software, or firmware components beyond those described or depicted without departing from the scope of the disclosure. More particularly, it should be appreciated that software, firmware, or hardware components depicted as forming part of the controller are merely illustrative and that some components may not be present or additional components may be provided in various embodiments. While various illustrative program module(s) have been depicted and described as software module(s) stored in the data storage, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-3 may be performed by a device having the illustrative configuration, or more specifically, by one or more engines, program module(s), applications, or the like executable on such a device. It should be appreciated, however, that such operations may be implemented in connection with numerous other device configurations.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines, and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a CRSM that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A system for maintaining a volume of fluid in a predetermined temperature range, the system comprising:
a thermal element configured to one or both of heat and cool the volume of fluid;
a sensor configured to detect a temperature of the volume of fluid; and
a controller configured to:
receive a signal from the sensor indicative of the temperature of the volume of fluid;
compare the temperature of the volume of fluid with a tolerance range comprising a set point between a lower limit and an upper limit;
switch the thermal element on or off in response to the comparison as a switching event;
determine a rate of switching events; and
adjust the tolerance range in response to the rate of switching events.

2. The system of claim 1, wherein the controller is configured to adjust the tolerance range to reduce the rate of switching events.

3. The system of claim 1, wherein the controller is configured to broaden the tolerance range by one or both of increasing the upper limit and reducing the lower limit.

4. The system of claim 3, wherein the controller is configured to broaden the tolerance range no more than a predetermined maximum upper limit and no less than a predetermined minimum lower limit.

5. The system of claim 1, wherein the controller is configured to, in a heating mode:
switch the thermal element on in response to determining that the temperature is less than the lower limit, and
switch the thermal element off in response to determining that the temperature is equal to or greater than the set point.

6. The system of claim 5, wherein the controller is configured to, in the heating mode, switch the thermal element off in response to determining that the temperature is equal to or greater than the upper limit.

7. The system of claim 1, wherein the controller is configured to, in a cooling mode:
switch the thermal element on in response to determining that the temperature is greater than the upper limit, and
switch the thermal element off in response to determining that the temperature is equal to or less than the set point.

8. The system of claim 7, wherein the controller is configured to, in the cooling mode, switch the thermal element off in response to determining that the temperature is equal to or less than the lower limit.

9. The system of claim 1, wherein the set point is an average of the lower limit and the upper limit.

10. The system of claim 1, wherein the set point is greater than the average of the lower limit and the upper limit.

11. The system of claim 1, wherein the set point is less than the average of the lower limit and the upper limit.

12. The system of claim 1, wherein the thermal element comprises a water heater, and wherein the volume of fluid is a volume of water.

13. The system of claim 1, wherein the thermal element comprises a heating, ventilation, and air conditioning (HVAC) component, and wherein the volume of fluid is a volume of air.

14. The system of claim 1, wherein the HVAC component is an air conditioner component, a heat pump component, or a furnace component.

15. A method for maintaining a volume of fluid in a predetermined temperature range, the method comprising:
receiving, by a controller, a signal from a sensor indicative of a temperature of the volume of fluid;
comparing, by the controller, the temperature of the volume of fluid with a tolerance range comprising a set point between a lower limit and an upper limit;
switching, by the controller, a thermal element on or off in response to the comparison as a switching event;
determining, by the controller, a rate of switching events; and
adjusting, by the controller, the tolerance range in response to the rate of switching events.

16. The method of claim 15, wherein the adjusting is configured to reduce the rate of switching events.

17. The method of claim 15, further comprising, by the controller, in a heating mode:
switching the thermal element on in response to determining that the temperature is less than the lower limit, and
switching the thermal element off in response to determining that the temperature is equal to or greater than the set point.

18. The method of claim 15, further comprising, by the controller, in a cooling mode:
switching the thermal element on in response to determining that the temperature is greater than the upper limit, and
switching the thermal element off in response to determining that the temperature is equal to or less than the set point.

19. The method of claim 15, wherein the set point is an average of the lower limit and the upper limit.

20. The method of claim 15, wherein the thermal element comprises a water heater, and wherein the volume of fluid is a volume of water.
